(19) United States
(12) Patent Application Publication
(10) Pub. No.: US 2022/0398113 A1
(43) Pub. Date: Dec. 15, 2022

(54) SYSTEMS AND METHODS FOR IMPLEMENTING REHYDRATION AUTOMATION OF VIRTUAL MACHINE INSTANCES

(71) Applicant: Capital One Services, LLC, McLean, VA (US)

(72) Inventors: Gyanendra Choudhary, Glen Allen, VA (US); Cooper Baird, Richmond, VA (US)

(21) Appl. No.: 17/343,557

(22) Filed: Jun. 9, 2021

(51) Int. Cl. G06F 9/455; G06F 9/445

(52) U.S. Cl. CPC G06F 9/45558; G06F 9/44505; G06F 2009/45579; G06F 2009/45562; G06F 2009/4557

(57) ABSTRACT

Systems and methods for updating Virtual Machines in cloud computing systems. Methods include automating machine image configuration changes and/or updates while monitoring and automatically remediating issues at selective nodes. Methods include initiating rehydration of a Virtual Machine based on a predetermined schedule, identifying, by a configuration update manager, resources available for updating the Virtual Machine, creating one or more updated configuration parameters based on the resources available for updating the Virtual Machine, creating an updated launch configuration based on the updated configuration parameters, detaching, from the Virtual Machine, a previous launch configuration, attaching, to the Virtual Machine for execution, the updated launch configuration; and terminating a previous Instance of the Virtual Machine based on the previous launch configuration.

### FIELD

This disclosure generally relates to updating (rehydrating) Virtual Machines in cloud computing systems. Embodiments disclosed herein relate to systems and methods that automate machine image configuration changes and/or updates while monitoring and automatically remediating issues at selective nodes.

### BACKGROUND

The term “cloud computing” generally refers to scalable computing platform resources that are accessible via the Internet. Such platforms can include databases, storage, applications, and other IT resources that support critical business operations without requiring large upfront investments in hardware and associated management costs. Cloud computing systems can be provisioned on the fly with the right type and size of computing resources to meet ever-changing business demands and associated technology updates.

AWS (Amazon Web Services) offers network-connected hardware for cloud computing services that can be provisioned and controlled via various applications. In a typical scenario, a company may seek to release a new software platform (or version of the platform) to take advantage of updated technology, address and correct problems associated with a current version, and/or address other factors related to a development cycle. If a development cycle moves forward, the new software platform release is planned and designed. A testing or quality assurance phase occurs in which the software application release is built, tested, retested, and revised until it meets any applicable requirements for a production-ready release. The software platform release then enters a deployment phase, where it is implemented and made available to applicable consumers. Once deployed, the software application release enters a support phase, where bug reports and other issues and requests are collected. When deciding to address any of these bug reports or other issues and requests, new requests for changes may be received, and the cycle may repeat for a new software platform release.

Current cloud computing environments excel at adding duplicated resources but are extremely cumbersome and inefficient when existing nodes need to be updated while maintaining their state. The current Amazon EC2 (Elastic Compute Cloud) maintained by an ASG (auto-scaling group) can handle expansions and updates, for example by adding a new node, then perhaps killing off the old node, while requiring resource volumes to have the same name. However, a full-time engineer is currently required to manually rehydrate a large number of nodes to keep the whole process of cluster nodes from rolling back to a previous state. Updating nodes in the current cloud computing environment is a race against time.

Accordingly, there is a need for improved systems and methods that can automate machine image configuration changes and/or updates, reduce failure, and generally improve efficiencies associated with the process of updating cloud software platforms. Embodiments of the present disclosure are directed to this and other considerations.

### BRIEF SUMMARY

Disclosed embodiments provide systems and methods for automatically updating a stateful Virtual Machine image associated with an auto-scaling group.

Consistent with the disclosed embodiments, a method is provided for automatically updating a stateful Virtual Machine image associated with a first auto-scaling group. The method includes initiating rehydration of a Virtual Machine based on a predetermined schedule, identifying, by a configuration update manager, resources available for updating the Virtual Machine, creating one or more updated configuration parameters based on the resources available for updating the Virtual Machine, creating an updated launch configuration based on the updated configuration parameters, detaching, from the Virtual Machine, a previous launch configuration, attaching, to the Virtual Machine for execution, the updated launch configuration, and terminating a previous Instance of the Virtual Machine based on the previous launch configuration.

Consistent with the disclosed embodiments, a system is provided for automatically updating a stateful Virtual Machine image associated with an auto-scaling group. The system includes a processor, and a memory having programming instructions stored thereon, which, when executed by the processor, cause the processor to initiate rehydration of a Virtual Machine based on a predetermined schedule, identify resources available for updating the Virtual Machine, create one or more updated configuration parameters based on the resources available for updating the Virtual Machine, create an updated launch configuration based on the updated configuration parameters, detach, from the Virtual Machine, a previous launch configuration, attach, for execution by the Virtual Machine, the updated launch configuration, and terminate a previous Instance of the Virtual Machine based on the previous launch configuration.

Consistent with the disclosed embodiments, non-transitory computer-readable storage media is disclosed having one or more sequences of instructions, which, when executed by one or more processors, causes the one or more processors to perform operations, comprising: initiating rehydration of a Virtual Machine based on a predetermined schedule, identifying resources available for updating the Virtual Machine, creating one or more updated configuration parameters based on the resources available for updating the Virtual Machine, creating an updated launch configuration based on the updated configuration parameters, detaching, from the Virtual Machine, a previous launch configuration, attaching, to the Virtual Machine for execution, the updated launch configuration, and terminating a previous Instance of the Virtual Machine based on the previous launch configuration.

Further features of the disclosed design and the advantages offered thereby are explained in greater detail hereinafter regarding specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which illustrate various implementations and aspects of the disclosed technology and, together with the description, serve to explain the principles of the disclosed technology.

FIG. 1 is a block diagram illustration of a computing environment, according to an exemplary implementation of the disclosed technology.

FIG. 2 is a block diagram illustration of a rehydration system with various modules for configuring, resolving, and updating (rehydrating) instances, according to an exemplary embodiment of the disclosed technology.

FIG. 3 depicts a Virtual Machine Refresh Controller consistent with certain exemplary implementations of the disclosed technology.

FIG. 4. illustrates hardware and software components that may be utilized in certain exemplary implementations of the disclosed technology.

FIG. 5 is a flow diagram of a method, according to an exemplary implementation of the disclosed technology.

### DETAILED DESCRIPTION

The disclosed technology includes systems and methods for automatically updating Virtual Machine images associated with one or more auto-scaling groups. Certain implementations disclosed herein may be utilized to overcome inefficiencies and other drawbacks associated with the conventional rehydration of Virtual Machine instances running on virtualization platforms. Certain implementations disclosed herein may be used to seamlessly and efficiently update a Virtual Machine image without having to resort to conventional processes in which the Virtual Machine is typically shut down and/or taken off-line while an updated image is downloaded and launch configurations are updated.

Certain implementations of the disclosed technology may utilize a Configuration Update Manager and/or a Resource Update Manager sub-systems to automatically identify and resolve issues associated with one or more applications hosted on a Virtual Machine. Certain implementations may update (rehydrate) an image or instance running on Virtual Machines with the resolved image or instance. The disclosed technology can be utilized to improve the overall health of one or more applications by providing an up-to-date image of each Virtual Machine and assessing the overall health of an application, such that resources can be dynamically added to improve the health of the application while minimizing or eliminating downtime.

The disclosed technology may be utilized to update an autoscaling group's launch configuration with a new image (such as an Amazon Machine image, (AMI)). Certain implementations may programmatically terminate nodes on a determined schedule to automatically propagate the latest image to utilize core build instances, change instances, update instances, refresh instances, and/or terminate instances.

In certain implementations, a script may be run on each instance (in the user data section, for example) to automatically monitor logs for any issues/failures and remediate them accordingly. The advantage to automatically rehydrating this way is that it ensures instances will launch without failure. Unlike manual processes (which roll back nodes in case of any failures), the disclosed technology may divide tasks into modules that can be worked up independently at any convenient time, without requiring that each task is done all at once. The disclosed automatic hydration processes may reduce man-hours by an order of magnitude over conventional rehydration processes. Furthermore, rehydration of a whole stack, which previously could take a week, can be reduced to near-zero time by using autonomous rehydration techniques disclosed herein.

It is intended that each term presented herein contemplates its broadest meaning as understood by those skilled in the art and may include all technical equivalents, which operate similarly to accomplish a similar purpose.

Ranges may be expressed herein as from “about” or “approximately” one particular value and/or to “about” or “approximately” another particular value. When such a range is expressed, another embodiment may include from the one particular value and/or to the other particular value. Similarly, values may be expressed herein as “about” or “approximately.”

The terms “comprising” or “containing” or “including” means that at least the named element, material, or method step is present in the apparatus or method, but does not exclude the presence of other elements, materials, and/or method steps, even if the other elements, materials, and/or method steps have the same function as what is named.

The term “exemplary” as used herein is intended to mean “example” rather than “best” or “optimum.”

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive.

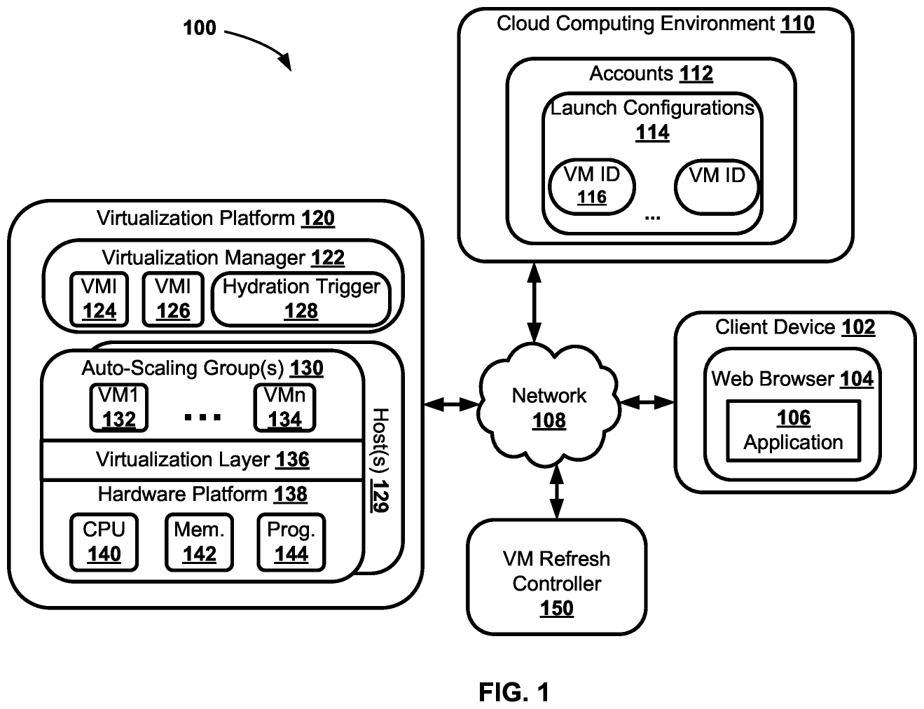

FIG. 1 is a block diagram illustration of a computing environment 100, according to an exemplary implementation of the disclosed technology. The computing environment 100 can include a client device 102, a cloud computing environment 110, a virtualization platform 120, and a Virtual Machine (VM) Refresh Controller 150, each configured to communicate over a network 108. The client device 102 may be a mobile device, a tablet, a desktop computer, or any computing system having the capabilities described herein. The client device 102 may execute a web browser 104, which may provide access to one or more applications 106 hosted on virtualization platform 120.

The network 108 may be any suitable network, including individual connections via the Internet (e.g., cellular, wireless networks, etc.). In some implementations, the network 108 may connect terminals, services, and computing devices using direct connections, such as radio-frequency identification (RFID), near-field communication (NFC), Bluetooth™, low-energy Bluetooth™ (BLE), WiFi™, ZigBee™, ambient backscatter communications (ABC) protocols, USB, WAN, LAN, and the like. In certain implementations, one or more of these types of connections can be encrypted or otherwise secured.

In accordance with certain exemplary implementations of the disclosed technology, the virtualization platform 120 may include a virtualization manager 122 that manages one or more Virtual Machine images VMI 124, VMI 126, etc. The Virtualization Manager 122 may include a Hydration Trigger 128 that may initiate rehydration of one or more Virtual Machine images VMI 124, VMI 126. Rehydration, for example, may include refreshing, adapting, and/or rebuilding an instance to accommodate changes to an instance and/or properties thereof.

In certain implementations, the virtualization platform 120 can include one or more host computer systems 129 (hosts). Each host 129 may include components of a computing device, such as one or more processors (CPUs) 140, memory 142, programming instructions 144, etc. The hosts 129 may further include a network interface, storage system, and I/O devices (not shown). The CPU 140 may be configured to execute instructions, such as programming instructions 144 that perform one or more operations described herein. The programming instructions 144 may be stored in memory 142 or local storage. The memory 142 may be embodied as a device configured to allow information, such as executable instructions, virtual disks, configurations, and the like, to be stored and retrieved. The memory 142 may include, for example, one or more random access memory (RAM) modules. The hosts 129 may communicate with another device via a communication medium, such as via a network interface adapter. A local storage device (e.g., one or more hard disk drives, flash memory modules, solid-state disks, and optical disks) and/or a storage interface may enable the hosts 129 to communicate with one or more network data storage systems.

In accordance with certain exemplary implementations of the disclosed technology, each host 129 can be configured to provide a virtualization layer 136 that abstracts processor, memory, storage, and networking resources of hardware platform 138 into multiple Virtual Machines VM1 132 . . . . VMn 134 (VMi's) in an Auto-Scaling Group 130 that may be configured to run concurrently on the same host. In certain implementations, the auto-scaling group VMi's may run on top of a software interface layer that enables sharing of hardware resources of the host 129. As illustrated, the Auto-Scaling Group 114 may include the set of auto-scaling group VMi's that include similar characteristics and that are grouped for purposes of management and scaling. For example, an application 106 running on the client device 102 may execute across the auto-scaling group 130. Depending on the health of application 106, several auto-scaling group VMi's in an auto-scaling group 130 may be increased or decreased dynamically.

In certain implementations, the virtualization manager 122 may be configured to communicate with the plurality of hosts 129 via the network 108. In some embodiments, the virtualization manager 122 is a computer program that resides on and/or executes in a central server, which may reside on the virtualization platform 120. In some embodiments, the virtualization manager 122 may run as a Virtual Machine in one of hosts 129. In certain implementations, the virtualization manager 122 may be configured to carry out administrative tasks for virtualization platform 120. The virtualization manager 122, for example, may manage hosts 129, manage auto-scaling group VMi's running within each host 129, provision auto-scaling group VMi's, migrate auto-scaling group VMi's, load balance among auto-scaling group VMi's, and increase or decrease the number of auto-scaling groups VMi's based on a health of an application executing across VMi's of the auto-scaling group 130.

In certain implementations, the virtualization manager 122 may store one or more Virtual Machine images (VMI 124, VMI 126, etc) associated with a given set of auto-scaling group VMi's (VM1 132 . . . VMn 134). In certain implementations, the VMI 124 and/or VMI 126 may be referred to as a template to create one or more auto-scaling group VMi's. For example, the VMI 124 and/or the VMI 126 may include files relating to the auto-scaling group VMi's, an operating system running thereon, provisioning information, and the like. A specific example of VMI 124 is an Amazon Machine Image (“AMI”) on Amazon Web Services (AWS) platform.

In accordance with certain exemplary implementations of the disclosed technology, the virtualization platform 120 may communicate with a cloud computing environment 110 via the network 108. The cloud computing environment 110 may store information associated with a user's virtualization platform 120. The cloud computing environment 110, for example, may include one or more accounts 112, each of which may correspond to a given user. In some embodiments, the cloud computing environment 110 may include one or more storage locations for the storage of information associated with the account(s) 112. In certain implementations, the information associated with the account(s) 112 may be stored in a directory, such as an Active Directory. In certain exemplary implementations, a protocol (such as a lightweight directory access protocol (LDAP)) may be utilized to authenticate and/or authorize users when they log-in and attempt to access services via the computing environment 100. In some embodiments, an account 112 may include (or be associated with) certain launch configurations 114. In certain implementations, the launch configurations 114 may include identification information 116 associated with the provisioning of VMi's (VM1 132 . . . VMn 134) in each auto-scaling group 130. In some embodiments, the launch configurations 114 may include information for provisioning, running, and/or testing associated VMi's (VM1 132 . . . VMn 134). In certain implementations, each VM ID 116 may correspond to a given Virtual Machine image (VMI 124, VMI 126, etc) stored in virtualization manager 122. As such, when the virtualization manager 122 provisions VMi's (VM1 132 . . . VMn 134) in the auto-scaling group 130, the virtualization manager 122 may reference respective launch configurations 114 in an associated account 112 to identify a corresponding VMI 124 (and/or VMI 126) via the VM ID 116.

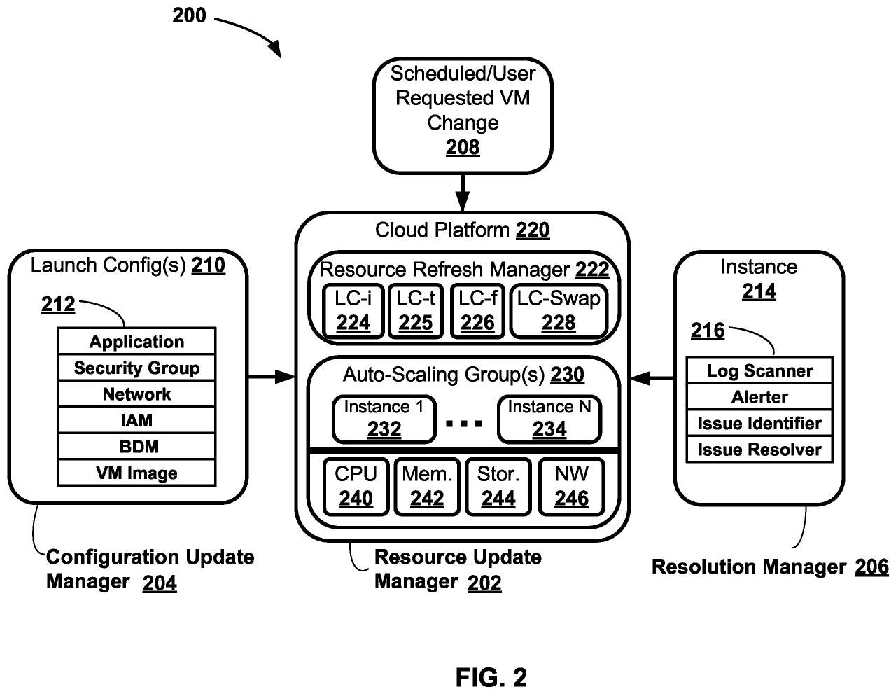

In previous (conventional) systems, when a virtualization platform provider would update an operating system of a Virtual Machine image, a user would necessarily have to shut down each Virtual Machine of an auto-scaling group, download a different version of the Virtual Machine image from an external source, and re-provision each Virtual Machine of the auto-scaling group with the different version of the Virtual Machine image. To address this issue, and in accordance with certain exemplary implementations of the disclosed technology, the virtualization manager 122 may further include a hydration trigger 128 configured to initiate real-time, near real-time, or periodic service to auto-scaling groups 130. In certain implementations, the hydration trigger 128 may leverage information included in the launch configuration 114 associated with an auto-scaling group 130 in servicing the auto-scaling group 130. Certain details of the hydration trigger 128 will now be discussed with reference to FIG. 2.

FIG. 2 is a block diagram illustration of a rehydration system 200 according to an exemplary embodiment of the disclosed technology. Certain functions and aspects of the rehydration system 200 can correspond to similar functions and aspects of the computing environment 100 discussed above with reference to FIG. 1. The rehydration system 200, for example, may correspond to and/or utilize certain functions of the hydration trigger 128 as discussed above with reference to FIG. 1. However, in certain implementations, the rehydration system 200 may be configured as a separate system, in which the Resource Update Manager 202 can be hosted on a cloud platform 220. In some implementations, the rehydration system 200 may utilize multiple computing devices. For example, a client device (such as the client device 102 discussed with reference to FIG. 1) may be utilized to request or schedule a Virtual Machine update. The rehydration system 200 can include various modules for configuring, resolving, triggering an update, and updating (rehydrating) Virtual Machine instances associated with one or more auto-scaling groups. In certain implementations, the Resource Update Manager 202 may be in communication with a Configuration Update Manager 204. In certain implementations, the Resource Update Manager 202 may be in communication with a Resolution Manager 204. In certain implementations, the Resource Update Manager 202 may receive scheduled and/or user-requested Virtual Machine changes 208, which may initiate or trigger a rehydration process, as will be explained below.

In accordance with certain exemplary implementations of the disclosed technology, the Configuration Update Manager 204 may include launch configurations 210 with specific launch parameters 212 that provide information for how a rehydration launch is to be configured. In certain implementations, the launch configurations 210 may be associated with one or more accounts (such as accounts 112 as discussed above with reference to FIG. 1). In other example implementations, the Configuration Update Manager 204 may store and manage the launch configurations 210 on a separate computing device without requiring the launch configurations 210 and/or associated functions to be hosted in a cloud computing environment (such as the Cloud Computing Environment 110 as discussed in reference to FIG. 1). The launch parameters 212 may include, for example, information about an application to update, information regarding a security group, information regarding the network, information regarding Identity Access Management (IAM), information regarding Block Device Mapping (BDM), and/or a Virtual Machine image. In certain implementations, the launch configurations 210, in conjunction with the launch parameters 212 may describe what IAM role needs to be used on a Virtual Machine and/or how the BDM would be attached to a Virtual Machine. The BDM, for example, may be used to define a mount point for storage on a Virtual Machine. In certain implementations, the IAM may be utilized to securely control who is authenticated and has authorized permission to use the various tools associated with the system 200. According to certain implementations, the BDM may refer to (or be associated with) allocation and/or mounting of block storage (such as Amazon's Elastic Block Store) which may be attached to an instance and utilized.

The Resolution Manager 206 may be utilized to monitor an Instance 214 for any failures and automatically remediate them accordingly. An Instance 214, for example, can be a Virtual Machine and/or an application. In certain implementations, the Instance 214 may be a copy of one or more live Instances 232-234 in an Auto-Scaling Group 230. In certain implementations, a script may be run with each Instance 214 that may interact with any one of several modules 216 associated with the Resolution Manager 206. The modules 216 can include a Log Scanner for monitoring for near-real-time automatic monitoring of log files for any issues associated with an Instance 214. In certain implementations, the Resolution Manager 206 can include an Alerter module configured to output one or more alerts when an issue is detected. In certain implementations, the Resolution Manager 206 can include an Issue Identifier that may be utilized to categorize the detected issue (which may be found by the Log Scanner, for example) and may further be utilized to determine similar issues that the system 200 has encountered with an instance. In certain implementations, the Resolution Manager 206 can include an Issue Resolver to automatically resolve detected/identified issues associated with the Instance 214. In certain implementations, the Issue Resolver may utilize machine learning to select and apply the correct resolution repair based on the identified issue, and on historical repairs that have solved the same or similar identified issue. According to an exemplary implementation of the disclosed technology, the Resolution Manager 206 may update the Instance 214 based on any detected/identified issues associated with the Instance 214 so that the Instance 214 is updated or pre-resolved prior to its use in updating one or more live Instances 232-234 in an Auto-Scaling Group 230.

With continued reference to FIG. 2, the Resource Update Manager 202 may be embodied as a cloud platform 220 configured to receive information from the Resolution Manager 206, for example, to update one or more live Instances 232-234 in one or more Auto-Scaling Group(s) 230 responsive to a scheduled or requested Virtual Machine change 208. In certain implementations, one or more live Instances 232-234 may be updated/rehydrated using the parameters 212 specified via launch configurations 210 and/or one or more Instances 214 pre-resolved by the Resolution Manager 206. The Resource Update Manager 202 may include a CPU 240, memory 242, storage 244, and networking components 246 for communication with the other system 200 components.

In certain implementations, the Resource Update Manager 202 may include a Resource Refresh Manager 222 with one or more Launch Configuration processing modules such as a Launch Configuration-initial module (LC-i) 224, a Launch Configuration-temporary module (LC-t) 225, a Launch Configuration-final (LC-f) 226 and a Launch Configuration Swapper (LC-Swap) 228. The modules 224-228 associated with the Resource Refresh Manager 222 may be used to temporarily store and swap Virtual Machine (VM) instances and/or managed instance groups (MIGs) so that Instances 232 . . . 234 of the Auto-Scaling Group(s) 230 may be quickly updated with minimal downtime. In certain implementations, one or more of the LC-i 224, LC-t 225, LC-f 226 may define the machine type, boot disk image, container image, labels, and other instance properties and/or instance parameters 212.

As will be explained below, the LC-i 224 may be utilized to store an original (initial) launch configuration, the LC-t 225 may store a (temporary) copy of the original launch configuration, and the LC-f 226 may store the (final) updated launch configuration. To coordinate efficient utilization of the Resource Refresh Manager 222, the LC-Swap 228 may be utilized to facilitate instance swapping using Launch Configurations 210 received from the Configuration Update Manager 204.

In accordance with certain exemplary implementations of the disclosed technology, the Resource Update Manager 202 may rehydrate one or more Instances 232-234 in the Auto-Scaling Group(s) 230 by detaching an old Virtual Machine image and attaching a new Virtual Machine image using Launch Configuration(s) 210 as provided by the Configuration Update Manager 204. In an exemplary embodiment, the Configuration Update Manager 204 may retain the same name of the Launch Configuration(s) 210 via a double-swap process. The two-time swap is done to conceal the underlying changes that may be made to update the Virtual Machine image, and/or any underlying changes in the associated parameters 212 so that other systems looking at Launch Configuration(s) 210 think that nothing has changed. Thus, in certain exemplary implementations, a whole new set of configuration parameters may be changed while keeping the name of the Launch Configuration(s) 210 as it was before the rehydration process. Thus, from the Auto-Scaling Group(s) 230 perspective, the attached Launch Configuration(s) 210 appear the same, but the parameters 212 and other configuration details defined Launch Configuration(s) 210 may be changed as needed, which enables an efficient change/rehydration of the associated Virtual Machine configuration without negatively impacting other parts of the system that rely on the particular Instance 232-234.

In accordance with certain implementations of the disclosed technology, the process may start with an original Launch Configuration 210 denoted, for example, “LaunchConfig_Original,” and may utilize the following steps:

Step 1: Copy LaunchConfig_Original and change all configurations to make Launch Configuration_Original_Copy;

Step 2: Detach LaunchConfig_Original from the Auto-Scaling Group 230;

Step 3: Attach LaunchConfig_Original_Copy to the Auto-Scaling Group 230;

Step 4: Delete the Auto-Scaling Group 230;

Step 5: Copy LaunchConfig_Original_Copy to re-create the LaunchConfig_Original;

Step 6: Detach the LaunchConfig_Original_Copy from the Auto-Scaling Group 230.

Step 7: Attach the LaunchConfig_Original to the Auto-Scaling Group 230 as it was before starting the process.

The steps above essentially define the double-swap process that can be represented as LaunchConfig_Original->LaunchConfig_Original_Copy->LaunchConfig_Original. As discussed above, one or more of the LC-i 224, LC-t 225, LC-f 226, coordinated by the LC-Swap 228 may be utilized to facilitate the double-swap process.

The above-referenced process may be performed to overcome a limitation where the Launch Configuration(s) 210 can only be copied or deleted, but not updated. The process described above enables the Launch Configuration(s) 210 name to remain the same for the cases where other systems (such as CloudFormation) may be looking for the same specific Launch Configuration name.

Certain implementations of the disclosed technology can include core (build instances), change (update Auto-Scaling Group), and refresh (Terminate instances). Certain implementations may be utilized to automate Apache Cassandra, which is a commonly used, high-performance NoSQL database. Amazon Web Service customers, for example, may maintain Cassandra on-premises to take advantage of the scalability, reliability, security, and economic benefits of running Cassandra on the Amazon Elastic Compute Cloud (EC2) platform, which may be utilized to eliminate a need to invest in hardware upfront. EC2 may be utilized to launch as many or as few virtual servers as needed, configure security and networking, manage storage, scale up or down to handle changes in requirements or spikes in popularity, reducing the need to forecast traffic, etc.

Certain implementations of the disclosed technology may rehydrate instances on EC2 by updating the Auto-scaling Group's 230 Launch Configuration(s) 210 with a new Amazon Machine Image (AMI) and programmatically terminate nodes on a schedule determined to automatically propagate the latest AMI. In certain implementations, a script may be run on each Instance 232-234 in the Cloud Platform 220 and/or Instance 224 monitored by the Resolution Manager 206 (for example, in the user data section) to automatically monitor logs for any failures so that they may be remediated.

One technical effect and advantage gained by the disclosed automatic rehydrating technology is that instances will come up and run without fail. Other technical effects and/or advantages gained by the disclosed technology are that the update (or attempted update) does not roll back all the nodes in case of any failures, as is often experienced in manual processes. Other technical effects and/or advantages gained by the disclosed technology are that the processes disclosed herein may reduce engineer man-hours required for rehydration, from the current approximate week it takes to manually rehydrate a whole stack down to minutes using autonomous self-driving programs. Certain implementations of the disclosed technology may break tasks into modules that can be worked up and run independently at any convenient time without requiring every step in the rehydration process to be done all at once.

In accordance with certain exemplary implementations of the disclosed technology, an Auto-Scaling Group 230 may include a list of all associated Instances 232-234. The Resource Update Manager 202 may utilize that list with a pre-defined Sequence/Order/Group (e.g., last created Virtual Machine or Availability Zone alphabetically, etc.) and may compare associated configuration on the Virtual Machine and the Launch Configuration(s) 210. The Resource Update Manager 202 may see that the Virtual Machine has an obsolete configuration that triggers a change. Otherwise, the Resource Update Manager 202 may move on to check the next Virtual Machine in the list. Once the Resource Update Manager 202 determines that a change is required, it may initiate a drain function on the Virtual Machine, which may wait for a client to finish, and then may accept no new service request for graceful termination. Once the drain function succeeds, the Resource Update Manager 202 may issue a Terminate command on the Virtual Machine using an AWS program. After the instance is terminated, the Resource Update Manager 202 may keep checking if it came back again at a defined interval (for example, 5 minutes for the 1st check and then every 30 seconds for the next subsequent check for 30 times). Once the updated version of the terminated instance is up and running, the Resource Update Manager 202 may move on to the next Virtual Machine.

Following certain exemplary implementations of the disclosed technology, once the Resource Update Manager 202 terminates the Virtual Machine, the Auto-Scaling Group 230 may observe that it has one Virtual Machine missing (or down)—so a new one may be created to replace the terminated Virtual Machine using changed Launch Configurations 210 that was updated. This is where the actual refresh of resources happens. Once a new Virtual Machine comes up, the Issue Identifier module and/or the Issue Resolver module(s) of the Resolution Manager 206 may be defined to run after the Virtual Machine boots up. In certain implementations, the Issue Identifier module and/or the Issue Resolver module(s) of the Resolution Manager 206 may then start scanning logs (using the Log Scanner) to find anomalies. The Issue Resolver module(s) of the Resolution Manager 206 may utilize resolution commands as soon as it identifies an issue and may issue such resolution commands to resolve the detected issue. In certain implementations, the Resolution Manager 206 may provide an indication that the Virtual Machine and/or all applications installed on the Virtual Machine are working normally, and/or that all milestones passed without any associated failures. In certain implementations, the Resolution Manager 206 may provide an indication that the Virtual Machine and/or one or more applications installed on the Virtual Machine are not working normally and/or that additional milestones still need to be completed. In certain implementations, the Resolution Manager 206 may communicate such indications via one or more electronic communication channels, such as instant messaging, text messaging, an automated chatbot (e.g., via a Slack channel), e-mail, push notification, etc. In case of a failure that the Resolution Manger 206 cannot fix, the Resolution Manager 206 may notify an administrator. The Resolution Manager 206 may notify the administrator via one or more electronic communication channels, such as instant messaging, text messaging, an automated chatbot (e.g., via a Slack channel), e-mail, push notification, etc. Once the administrator resolves the issue, the Resource Update Manager 202 may identify what resolution was applied and may update its Storage Repository 244 so that the next time the same issue is identified, the Resource Update Manager 202 can fix the issue without human intervention.

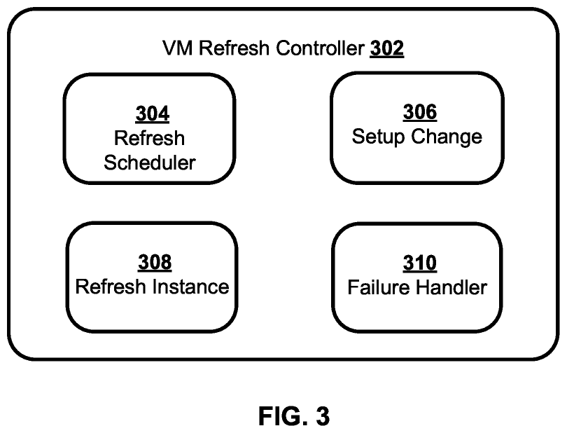

FIG. 3 depicts a Virtual Machine Refresh Controller 302, consistent with certain exemplary implementations of the disclosed technology. The Virtual Machine Refresh Controller 302 can include one or more of a Refresh Scheduler 304, a Setup Change Module 306, a Refresh Instance Module 308, and/or a Failure Handler 310. The Virtual Machine Refresh Controller 302, as depicted in FIG. 3, may represent a high-level abstraction of the processes discussed above concerning the rehydration system 200 as discussed in FIG. 2. For example, the Refresh Scheduler 304 may be configured to communicate and/or initiate the Virtual Machine (requested or scheduled) changes via the Resource Update Manager 202. In certain exemplary implementations, the Setup Change Module 306 may embody or encompass certain features or functions of the Configuration Update Manager 204 and/or the Resolution Manager 206. For example, the Setup Change Module 306 may utilize an Instance 214 that has already been resolved by the Resolution Manager 206, for example, using an initial setup, so that known/preventable issues are not introduced when a Virtual Machine is rehydrated. In certain implementations, the Setup Change Module 306 may interface with the Configuration Update Manager 204 to coordinate the use of the new Launch Configurations 210. The Refresh Instance Module 308 may embody or encompass certain features or functions of the Resource Update Manager 202 for refreshing/rehydrating Instances 232-334 in the Auto-Scaling Group(s) 230. The Failure Handler 310 may embody or encompass certain features or functions of the Resolution Manager 206, for example, to resolve/handle certain failures and/or errors in a previous or new Instance 214.

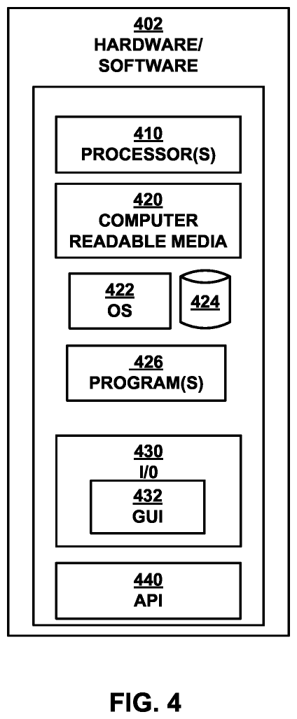

FIG. 4 is an expanded block diagram of the example hardware and software 402 components according to an aspect of the disclosed technology, which may include one or more of the following: one or more processors 410, a non-transitory computer-readable medium 420, an operating system 422, memory 424, one or more programs 426 including instructions that cause the one or more processors 410 to perform certain functions; an input/output (“I/O”) device 430, and an application program interface (API) 440, among other possibilities. The I/O device 430 may include a graphical user interface 432.

In certain embodiments, that API interface 440 may utilize real-time APIs such as Representational State Transfer (REST) style architecture. In certain embodiments, a real-time API may include a set of Hypertext Transfer Protocol (HTTP) request messages and a definition of the structure of response messages. In certain aspects, the API may allow a software application, which is written against the API and installed on a client to exchange data with a server that implements the API in a request-response pattern. In certain embodiments, the request-response pattern defined by the API may be configured synchronously and require that the response be provided in real-time. In some embodiments, a response message from the server to the client through the API consistent with the disclosed embodiments may be in the format including, for example, Extensible Markup Language (XML), JavaScript Object Notation (JSON), and/or the like.

In some embodiments, the API design may also designate specific request methods for a client to access the server. For example, the client may send GET and POST requests with parameters URL-encoded (GET) in the query string or form-encoded (POST) in the body (e.g., a form submission). Alternatively, the client may send GET and POST requests with JSON serialized parameters in the body. Preferably, the requests with JSON serialized parameters use “application/j son” content type. In another aspect, an API design may also require the server to implement the API return messages in JSON format in response to the request calls from the client.

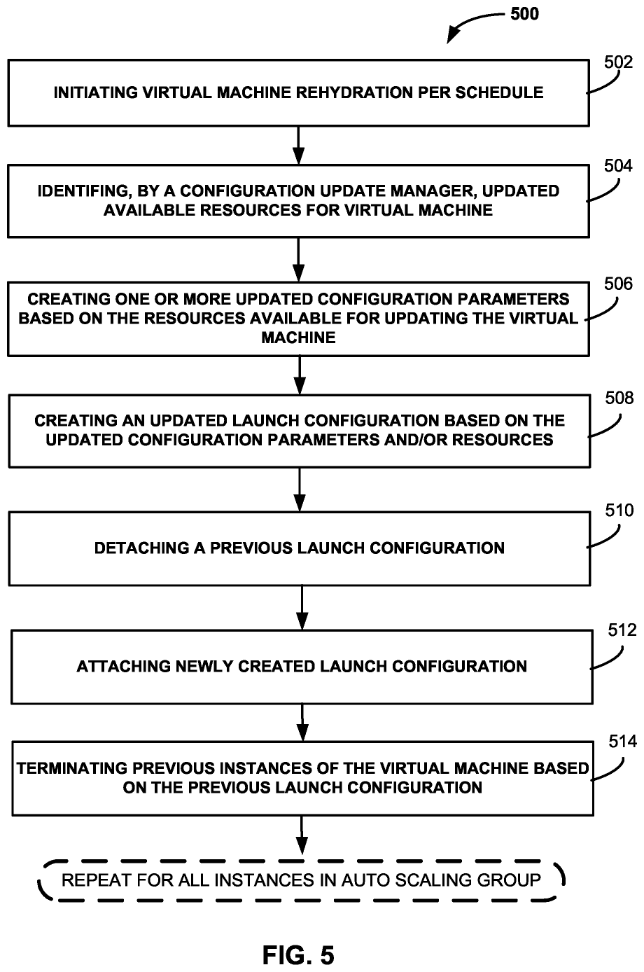

FIG. 5 is a flow diagram of a method 500, according to an exemplary implementation of the disclosed technology. The method 500 may be utilized to automatically update a stateful Virtual Machine image associated with a first auto-scaling group. In block 502, the method 500 can include initiating rehydration of a Virtual Machine based on a predetermined schedule. In block 504, the method 500 can include identifying, by a configuration update manager, resources available for updating the Virtual Machine. In block 506, the method 500 can include creating one or more updated configuration parameters based on the resources available for updating the Virtual Machine. In block 508, the method 500 can include creating an updated launch configuration based on the updated configuration parameters and/or resources. In block 510, the method 500 can include detaching, from the Virtual Machine, a previous launch configuration. In block 512, the method 500 can include attaching, to the Virtual Machine for execution, the updated launch configuration. In block 514, the method 500 can include terminating a previous instance of the Virtual Machine based on the previous launch configuration.

Certain implementations can further include selecting the first auto-scaling group based on a negative health rating of an application executing on the previous instance of the Virtual Machine. In some implementations, a second auto-scaling group may be selected based on a positive health rating of an application executing on the previous instance of the Virtual Machine associated with the first auto-scaling group. In accordance with certain exemplary implementations of the disclosed technology, the negative health rating and/or the positive health rating may be based on (or derived from) information gathered by one or more of the modules 216 of the Resolution Manager 206. For example, the Resolution Manager 206 may monitor one or more Instances 214 corresponding to live Instances 232-234 in an Auto-Scaling Group 230. In accordance with an exemplary implementation, when the Resolution Manager 206 starts to monitor a new Instance 214, the associated health rating may default to a positive health rating until an issue is identified. Responsive to a detected issue that has not yet been resolved, the health rating may be adjusted or switched to reflect a negative health rating. In this respect, certain implementations of the disclosed technology may select the first and/or second auto-scaling group based on the monitored Instance 214 and associated information via the Resolution Manager 206.

In some implementations, the resources can include one or more of: an application, a security group, a network, Block Device Mapping (BDM), Identity Access Management (IAM), and a Virtual Machine Image. In certain implementations, the BDM may define a mount point for storage on a Virtual Machine.

In certain implementations, attaching the updated launch configuration can include naming the updated launch configuration the same name as the previous launch configuration.

In some implementations, attaching the updated launch configuration can include concealing changes made between the previous launch configuration and the updated launch configuration by performing two swap processes comprising one or more of copy, detach, attach, and delete.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general-purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general-purpose machines as computer processing instructions, all or a portion of the functionality of the disclosed embodiments may be implemented instead in dedicated electronics hardware.

The disclosed embodiments also relate to tangible and non-transitory computer-readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high-level and/or low-level software instructions, such as machine code (e.g., such as that produced by a compiler) and/or high-level code that can be executed by a processor using an interpreter.

A peripheral interface may include the hardware, firmware, and/or software that enables communication with various peripheral devices, such as media drives (e.g., magnetic disk, solid-state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

A mobile network interface may provide access to a cellular network, the Internet, or another wide-area or local area network. In some embodiments, a mobile network interface may include hardware, firmware, and/or software that allows the processor(s) 404 to communicate with other devices via wired or wireless networks, whether local or wide area, private or public, as known in the art. A power source may be configured to provide an appropriate alternating current (AC) or direct current (DC) to power components.

The one or more processors 404 may include one or more of a microprocessor, microcontroller, digital signal processor, co-processor, or the like or combinations thereof capable of executing stored instructions and operating upon stored data. The memory 410 may include one or more suitable types of memory (e.g. such as volatile or non-volatile memory, random access memory (RAM), read-only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data within the memory 410.

The one or more processors 404 may be one or more known processing devices, such as but not limited to, a microprocessor from the Pentium™ family manufactured by Intel™ or the Turion™ family manufactured by AMD™. The one or more processors 410 may constitute a single core or multiple-core processor that executes parallel processes simultaneously. For example, a processor 410 may be a single-core processor that is configured with virtual processing technologies. In certain embodiments, one or more processors 410 may use logical processors to simultaneously execute and control multiple processes. The one or more processors 410 may implement Virtual Machine technologies, or other similar known technologies to provide the ability to execute, control, run, manipulate, store, etc. multiple software processes, applications, programs, etc. One having ordinary skill in the art would understand that other types of processor arrangements could be implemented that provide for the capabilities disclosed herein.

In certain exemplary implementations of the disclosed technology, the memory may include one or more memory devices that store data and instructions used to perform one or more features of the disclosed embodiments. The memory may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 410 may include software components that, when executed by one or more processors 404, perform one or more processes consistent with the disclosed embodiments. In some embodiments, the memory may include a database for storing related data to perform one or more of the processes and functionalities associated with the disclosed embodiments.

Following certain exemplary implementations of the disclosed technology, one or more features may be pre-computed and stored for later retrieval and used to provide improvements in processing speeds.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. Also, these components can execute from various computer-readable media having various data structures stored thereon. The components may communicate by way of local and/or remote processes such as by a signal having one or more data packets, such as data from one component interacting with another component in a local system, distributed system, and/or across a network such as the Internet with other systems by way of the signal.

Certain embodiments and implementations of the disclosed technology are described above regarding block and flow diagrams of systems and methods and/or computer program products. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above concerning user devices may include mobile computing devices. Those skilled in the art recognize that there are several categories of mobile devices, generally known as portable computing devices that can run on batteries but are not usually classified as laptops. For example, mobile devices can include but are not limited to portable computers, tablet PCs, internet tablets, PDAs, ultra-mobile PCs (UMPCs), wearable devices, and smartphones. Additionally, implementations of the disclosed technology can be utilized with the internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Throughout the specification and the claims, the following terms take at least the meanings explicitly associated herein, unless the context dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in the article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Case

The disclosed technology may be utilized in certain exemplary use cases to facilitate updating/rehydrating Virtual Machine Instances (and/or associated applications) with minimal impact to users of the associated data.

In one exemplary use case, an EC2 (Amazon Elastic Compute Cloud) may be utilized as scalable computing capacity for hosting an Instance on a Virtual Machine. The Instance may have a “state” that is characterized by an attached database and/or volume, and the state/database may not be changed while it is being used, otherwise, it could negatively impact whoever is using the database or the associated Instance. In such an exemplary use case, a policy may specify that not more than one Instance can go down and/or be offline for more than a predetermined period.

A polling process may be utilized to check Instances on the EC2 to determine if any Virtual Machine Instances need to be updated/rehydrated. To minimize disruption to users of the Virtual Machine when it needs to be updated, it may be necessary to schedule a maintenance period and/or temporarily suspend user access while an Instance is being updated.

The updating process may include detaching a volume, building a new Instance, replacing the old Instance with the new Instance (as discussed herein using the swapping process), re-attaching the volume, bringing the Virtual Machine with the new Instance online, and allowing access to the updated Instance. In certain exemplary use cases, this update process may take approximately 10 minutes to perform. The disclosed technology may help minimize downtime of the Virtual Machine by pre-resolving any issues associated with the new Instance.

1. A method of automatically updating a stateful Virtual Machine image, comprising:
initiating rehydration of a Virtual Machine associated with a first auto-scaling group based on a predetermined schedule;
identifying, by a configuration update manager, resources available for updating the Virtual Machine;
creating one or more updated configuration parameters based on the resources available for updating the Virtual Machine;
creating an updated launch configuration based on the updated configuration parameters;
detaching, from the Virtual Machine, a previous launch configuration;
attaching the updated launch configuration to the Virtual Machine for execution; and
terminating a previous Instance of the Virtual Machine based on the previous launch configuration.

2. The method of claim 1, further comprising selecting the first auto-scaling group based on a negative health rating of an application executing on the previous Instance of the Virtual Machine.

3. The method of claim 2, wherein a second auto-scaling group is selected based on a positive health rating of an application executing on the previous Instance of the Virtual Machine associated with the first auto-scaling group.

4. The method of claim 1, wherein the resources comprise one or more of: an application, a security group, a network, Block Device Mapping (BDM), Identity Access Management (IAM), and a Virtual Machine Image.

5. The method of claim 4, wherein the BDM defines a mount point for storage on the Virtual Machine.

6. The method of claim 1, wherein the attaching the updated launch configuration comprises naming the updated launch configuration a same name as the previous launch configuration.

7. The method of claim 6, wherein the attaching the updated launch configuration further comprises concealing changes made between the previous launch configuration and the updated launch configuration by performing two swap processes comprising one or more of copy, detach, attach, and delete.

8. A system for automatically updating a stateful Virtual Machine image, comprising:
a processor; and
a memory having programming instructions stored thereon, which, when executed by the processor, cause the processor to:
initiate rehydration of a Virtual Machine associated with a first auto-scaling group based on a predetermined schedule;
identify resources available for updating the Virtual Machine;
create one or more updated configuration parameters based on the resources available for updating the Virtual Machine;
create an updated launch configuration based on the updated configuration parameters;
detach, from the Virtual Machine, a previous launch configuration;
attach the updated launch configuration to the Virtual Machine for execution; and
terminate a previous Instance of the Virtual Machine based on the previous launch configuration.

9. The system of claim 8, wherein the programming instructions further cause the processor to select the first auto-scaling group based on a negative health rating of an application executing on the previous Instance of the Virtual Machine.

10. The system of claim 9, wherein the programming instructions further cause the processor to select a second auto-scaling group, wherein the second auto-scaling group is selected based on a positive health rating of an application executing on the previous Instance of the Virtual Machine associated with the first auto-scaling group.

11. The system of claim 8, wherein the resources comprise one or more of: an application, a security group, a network, Block Device Mapping (BDM), Identity Access Management (IAM), and a Virtual Machine Image.

12. The system of claim 11, wherein the BDM defines a mount point for storage on the Virtual Machine.

13. The system of claim 8, wherein the updated launch configuration is attached by naming the updated launch configuration a same name as the previous launch configuration.

14. The system of claim 13, wherein the updated launch configuration is attached to conceal changes made between the previous launch configuration and the updated launch configuration by performing two swap processes comprising one or more of copy, detach, attach, and delete.

15. A non-transitory computer-readable medium including one or more sequences of instructions, which, when executed by one or more processors, causes the one or more processors to perform operations, comprising:
initiating rehydration of a Virtual Machine associated with a first auto-scaling group based on a predetermined schedule;
identifying resources available for updating the Virtual Machine;
creating one or more updated configuration parameters based on the resources available for updating the Virtual Machine;
creating an updated launch configuration based on the updated configuration parameters;
detaching, from the Virtual Machine, a previous launch configuration;
attaching the updated launch configuration to the Virtual Machine for execution; and
terminating a previous Instance of the Virtual Machine based on the previous launch configuration.

16. The non-transitory computer-readable medium of claim 15, further comprising selecting the first auto-scaling group based on a negative health rating of an application executing on the previous Instance of the Virtual Machine.

17. The non-transitory computer-readable medium of claim 15, wherein a second auto-scaling group is selected based on a positive health rating of an application executing on the previous Instance of the Virtual Machine associated with the first auto-scaling group.

18. The non-transitory computer-readable medium of claim 15, wherein the resources comprise one or more of: an application, a security group, a network, Block Device Mapping (BDM), Identity Access Management (IAM), and a Virtual Machine Image, wherein the BDM defines a mount point for storage on the Virtual Machine.

19. The non-transitory computer-readable medium of claim 15, wherein the attaching the updated launch configuration comprises naming the updated launch configuration a same name as the previous launch configuration.

20. The non-transitory computer-readable medium of claim 19, wherein the attaching the updated launch configuration further comprises concealing changes made between the previous launch configuration and the updated launch configuration by performing two swap processes comprising one or more of copy, detach, attach, and delete.
